(19) United States
(12) Patent Application Publication
(10) Pub. No.: US 2025/0272275 A1
(43) Pub. Date: Aug. 28, 2025

(54) ELECTRONIC SHOP FINDINGS REPORT COMMON MESSAGE STRUCTURE

(71) Applicant: AEROXCHANGE LTD., Farmers Branch, TX (US)

(72) Inventors: Suriya Ganesan, Irving, TX (US); Albert Koszarek, Southlake, TX (US); Narayan Moni, Lewisville, TX (US)

(21) Appl. No.: 19/059,457

(22) Filed: Feb. 21, 2025

Related U.S. Application Data
(60) Provisional application No. 63/557,320, filed on Feb. 23, 2024.

(51) Int. Cl. G06F 16/23

(52) U.S. Cl. CPC G06F 16/23

(57) ABSTRACT

A computer-implemented method includes populating, by a service seller, an electronic shop findings report (SFR). The service seller transmits the electronic SFR to an electronic business network (EBN). The EBN received the electronic SFR and converts the electronic SFR into a data format requested by an aircraft operator. The EBN transmits the electronic SFR to an aircraft operator. The aircraft operator performs analysis on data retrieved from the electronic SFR.

### BACKGROUND

Currently in the aircraft industry, service sellers (e.g., repair vendors) populate a shop findings report (SFR) with issues found (e.g., worn or damaged aircraft parts), what issues were addressed (e.g., a part was repaired or replaced), and future recommendations (e.g., a particular part should be repaired or replaced within six months). The SFR reports are typically generated as a portable document format (PDF) document and transmitted through an electronic business network for use by aircraft operators. The data in the PDF SFRs must then be converted into other data formats by the electronic business network and/or aircraft operator for use/analysis in internal systems.

### SUMMARY

The present disclosure describes an electronic shop findings report (SFR) common message structure.

In an implementation, a computer-implemented method, comprises: populating, by a service seller, an electronic shop findings report (SFR); transmitting, by the service seller, the electronic SFR to an electronic business network (EBN); receiving, by the EBN, the electronic SFR; converting, by the EBN, the electronic SFR, into a data format requested by an aircraft operator; transmitting, by the EBN, the electronic SFR to an aircraft operator; and performing, by the aircraft operator, analysis on data retrieved from the electronic SFR.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, instead of data being entered into a portable document format (PDF) document or other data format to be converted by an electronic business network and/or an aircraft operator into a data format supported by internal systems, the described approach generates an electronic SFR in a common message structure (e.g., Extensible Markup Language (XML)). Second, the generation/transmission/analysis of the electronic SFR in the described approach decreases data entry errors and reduces security leaks. Third, data precision, can be increased as data does not have to be entered/reentered/verified multiple times and automated data checking tools can be leveraged on data in the electronic SFR. Fourth, data processing efficiency can be enhanced as data can be generally entered once and once verified trusted to be accurate. Fifth, predictability can be increased. For example, many processes following data entry can be automated to avoid users inadvertently failing to perform steps with respect to a typical PDF SFR. Sixth, data stored by the electronic SFR typically takes up less computer memory than an equivalent PDF document storing the same data. This reduction in need for computer memory can reduce the need for computer storage (both computer memory and storage memory), increases data transfer rates, reduces power consumption, and increases overall processing of the applicable data using a computer processor.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a description of an electronic shop findings report (SFR) common message structure, according to an implementation of the present disclosure.

FIG. 2A is a partial representation of an Extensible Markup Language (XML) schema for representing an example electronic SFR common message structure, according to an implementation of the present disclosure.

FIG. 2B is a continuation of the partial example representation of the XML schema of FIG. 2A for representing an example electronic SFR common message structure, according to an implementation of the present disclosure.

FIG. 2C is a continuation of the partial representation the XML schema of FIGS. 2A and 2B, respectively, for representing an example electronic SFR common message structure, according to an implementation of the present disclosure.

FIG. 3 is a flowchart illustrating an example of a computer-implemented method for providing an Electronic SFR Common Message Structure, according to an implementation of the present disclosure.

FIG. 4 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes for providing an electronic shop findings report (SFR) common message structure and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted to not obscure one or more described implementations. The present disclosure is not intended to be limited to the described or illustrated implementations, but to be accorded the widest scope consistent with the described principles and features.

Currently in the aircraft industry, service sellers (e.g., repair vendors) populate a shop findings report (SFR) with issues found (e.g., worn or damaged aircraft parts), what issues were addressed (e.g., a part was repaired or replaced), and future recommendations (e.g., a particular part should be repaired or replaced within 6 months). The SFR reports are typically generated as a portable document format (PDF) document and transmitted through an electronic business network for use by aircraft operators. The data in the PDF SFRs must then be converted into other formats by the electronic business network and/or the aircraft operator for use/analysis in internal computing systems. For example, the PDF SFR can be converted from PDF into MICROSOFT EXCEL or other file format and then be analyzed by artificial intelligence (AI) or statistical analysis tools.

In a conversion process from PDF to other data formats, data must be read and keyed into a computing system, which introduces the possibility of data entry errors, security leaks, lack of precision, inefficient data processing, errors in data verification, and lack of predictability (e.g., a service seller may fail to send data).

However, in the described approach, instead of data being entered into a PDF or other data format to subsequently be converted by an electronic business network and/or an aircraft operator into a data format supported by other internal systems, the described approach generates an electronic SFR by a service seller in a common message structure (e.g., Extensible Markup Language (XML)). The electronic SFR can then be transmitted to the electronic business network and/or aircraft operator. Data from the electronic SFR can be directly ingested and processed by internal computer systems without conversion, and processed, for example, for AI or statistical analysis reports (e.g., reliability analysis of parts, parts outside OEM specifications/tolerances, or what part(s) fail most often). As another example, reliability analysis can include what aircraft parts were ordered the most or what aircraft type had the most reported or discovered issues (e.g., model, configuration, or wide body/narrow body).

The generation/transmission/analysis of the electronic SFR in the described approach decreases data entry errors, reduces security leaks, increases data precision (e.g., data does not have to be entered/reentered/verified multiple times and automated data checking tools can be leveraged), enhances data processing (e.g., data can be generally entered once and once verified trusted to be accurate), and increases predictability (e.g., many processes following data entry can be automated to avoid users inadvertently failing to perform steps with respect to a typical PDF SFR). Moreover, typically, the data stored by the electronic SFR takes up less computer memory than an equivalent PDF document storing the same data. This reduction in need for computer memory can reduce the need for computer storage (both computer memory and storage memory), increases data transfer rates, reduce power consumption, and increase overall processing of the applicable data using a computer processor.

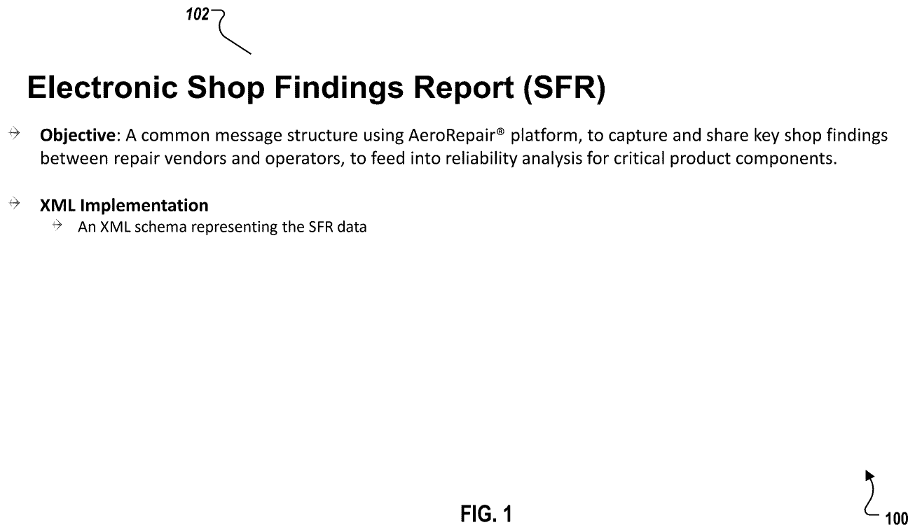

FIG. 1 is a description of an electronic shop findings report (SFR), according to an implementation of the present disclosure. An objective is to generate the electronic SFR 102 in a common message structure (e.g., in XML) to represent the electronic SFR 102. The electronic SFR 102 can be used to capture and share key shop findings (e.g., between a service seller and aircraft operators) to fee into reliability analysis systems for critical product components.

While this disclosure is focused on the use of an XML schema, as will be appreciated by those of ordinary skill in the art, any appropriate data format representing the described data structure is envisioned to be covered by the scope of this disclosure. Further, while specific data types and structures may be represented, as will be understood by those of ordinary skill in the art, representation of data can vary, and this disclosure is not considered to be limited only to the express example representation.

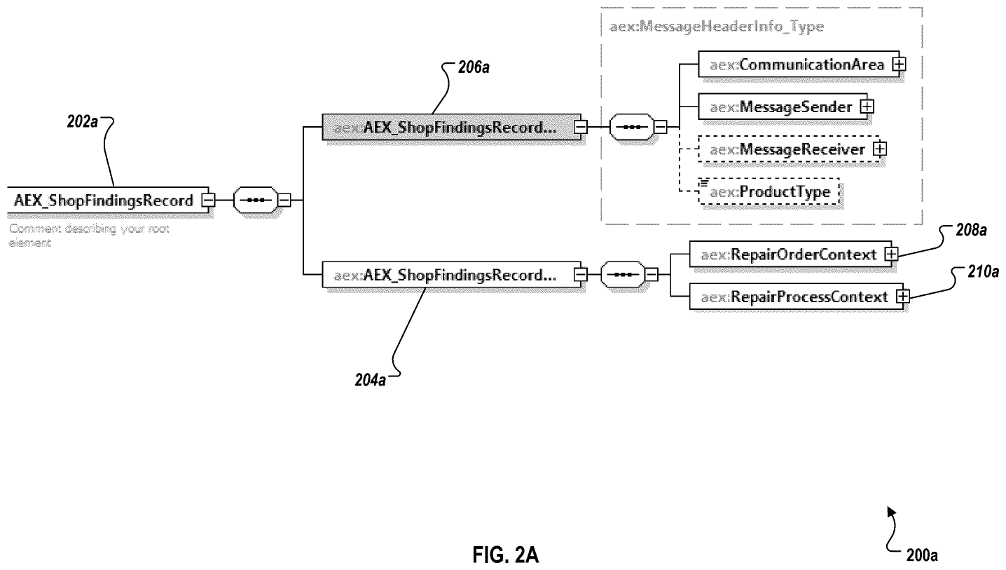

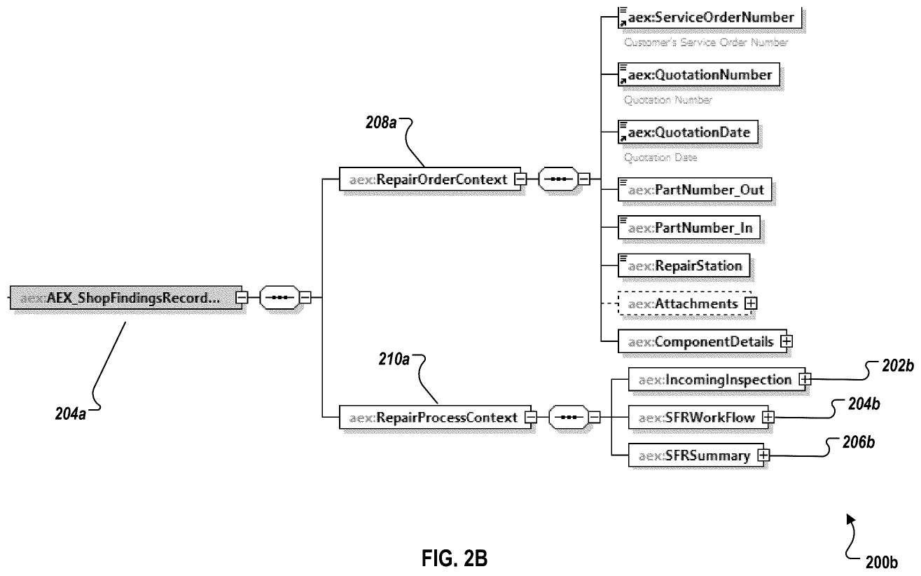

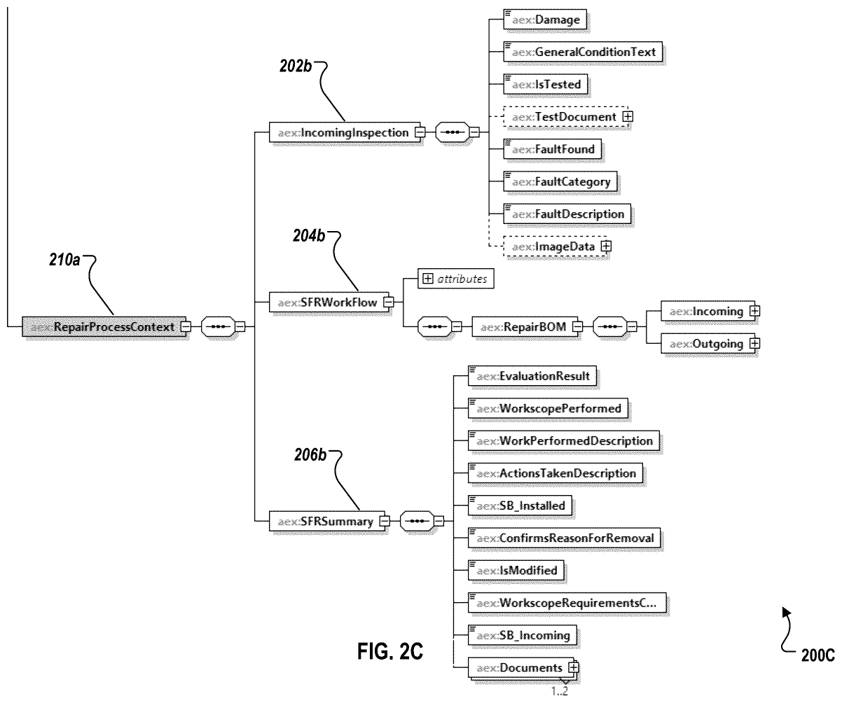

FIG. 2A is a partial representation 200a of an XML schema for representing an example electronic SFR common message structure, according to an implementation of the present disclosure. “AEX_ShopFindingsRecord” 202a is the root element of the XML schema for the example electronic SFR common message structure. One possible XML schema implementation of “AEX_ShopFindingsRecord” 202a follows. The illustrated XML schema hierarchy of FIG. 2A divides root element 202a into two child elements “aex:AEX_ShopFindingsRecordDetails” 204a and “aex:AEX_ShopFindingsRecordHeader” 206a. Focusing on child element 204a, “aex:AEX_ShopFindingsRecordDetails” 204a is further divided into child elements “aex:RepairOrderContext” 208a and “aex:RepairProcessContext” 210a. Child elements 208a and 210a are further defined in FIG. 2B.

In some implementations, the data type AEX_ShopFindingsRecord 202a of FIG. 2A can be implemented as:
<? xml version=“1.0” encoding=“UTF-8”?>
<!--edited with XMLSpy v2024 (x64) (http://www.altova.com) by sganesan (Aeroxchange, Ltd.)-->
<xs:schema xmlns:aex=“http://www.aeroxchange.com”
xmlns:xs=“http://www.w3.org/2001/XMLSchema”
targetNamespace=“http://www.aeroxchange.com” elementFormDefault=“qualified”
attributeFormDefault=“unqualified” version=“1.0” id=“R2024.1”>
   <xs:include schemaLocation=“AEX_RepairCommonTypes_Namespace.xsd”/>
   <xs:include schemaLocation=“ . . . /common/AEX_MasterCommonTypes.xsd”/>
   <xs:element name=“AEX_ShopFindingsRecord”>
      <xs:annotation>
         <xs:documentation>Comment describing your root element</xs:documentation>
      </xs:annotation>
      <xs:complexType>
         <xs:sequence>
         <xs:element name=“AEX_ShopFindingsRecordHeader”
type=“aex:MessageHeaderInfo_Type”/>
   <xs:element name=“AEX_ShopFindingsRecordDetails”>
      <xs:complexType>
         <xs:sequence>
         <xs:element name=“RepairOrderContext”>
         <xs:complexType>
         <xs:sequence>
         <xs:element ref=“aex:ServiceOrderNumber”/>
         <xs:element ref=“aex:QuotationNumber”/>
         <xs:element ref=“aex:QuotationDate”/>
         <xs:element name=“PartNumber_Out”/>
         <xs:element name=“PartNumber_In”/>
         <xs:element name=“RepairStation”/>
         <xs:element name=“Attachments” minOccurs=“0”>
         <xs:complexType>
         <xs:sequence>
         <xs:element ref=“aex:FileReference”/>
         </xs:sequence>
         </xs:complexType>
         </xs:element>
         <xs:element name=“ComponentDetails”>
         <xs:complexType>
         <xs:sequence>
         <xs:element ref=“aex:SerialNumber”/>
         <xs:element name=“WorkscopeDescription”/>
         <xs:element ref=“aex:RepairPriceAmount”/>
         <xs:element ref=“aex:QuotedTAT”/>
         <xs:element name=“RemovalDate”/>
         <xs:element name=“RemovalReasonCode”/>
         <xs:element name=“RemovalTypeCode”/>
         <xs:element name=“MaintenanceSpecifications”>
         <xs:complexType>
         <xs:sequence>
         <xs:element name=“Cycles” minOccurs=“0” maxOccurs=“6”>
         <xs:complexType>
         <xs:attribute name=“RefCode”/>
         </xs:complexType>
         </xs:element>
         <xs:element name=“Hours” minOccurs=“0” maxOccurs=“6”>
         <xs:complexType>
         <xs:attribute name=“RefCode”/>
         </xs:complexType>
         </xs:element>
         </xs:sequence>
         </xs:complexType>
         </xs:element>
         <xs:element name=“Findings”/>
         </xs:sequence>
         </xs:complexType>
         </xs:element>
         </xs:sequence>
         </xs:complexType>
         </xs:element>
         <xs:element name=“RepairProcessContext”>
         <xs:complexType>
         <xs:sequence>
         <xs:element name=“IncomingInspection”>
         <xs:complexType>
         <xs:sequence>
         <xs:element name=“Damage”/>
         <xs:element name=“GeneralConditionText”/>
         <xs:element name=“IsTested”/>
         <xs:element name=“TestDocument” minOccurs=“0”>
         <xs:complexType>
         <xs:sequence>
         <xs:element ref=“aex:FileReference”/>
         </xs:sequence>
         </xs:complexType>
         </xs:element>
         <xs:element name=“FaultFound”/>
         <xs:element name=“FaultCategory”/>
         <xs:element name=“FaultDescription”/>
         <xs:element name=“ImageData” minOccurs=“0”>
         <xs:complexType>
         <xs:sequence>
         <xs:element ref=“aex:FileReference”/>
         </xs:sequence>
         </xs:complexType>
         </xs:element>
         </xs:sequence>
         </xs:complexType>
         </xs:element>
         <xs:element name=“SFRWorkFlow”>
         <xs:complexType>
         <xs:sequence>
         <xs:element name=“RepairBOM”>
         <xs:complexType>
         <xs:sequence>
         <xs:element name=“Incoming”>
         <xs:complexType>
         <xs:sequence>
         <xs:element ref=“aex:PartNumber”/>
         <xs:element name=“PartShortDesc”/>
         <xs:element ref=“aex:SerialNumber”/>
         <xs:element name=“PMA”/>
         <xs:element name=“Condition”/>
         <xs:element name=“Action”/>
         <xs:element name=“PrimaryFault”/>
         </xs:sequence>
         </xs:complexType>
         </xs:element>
         <xs:element name=“Outgoing”>
         <xs:complexType>
         <xs:sequence>
         <xs:element ref=“aex:PartNumber”/>
         <xs:element name=“PartShortDesc”/>
         <xs:element name=“PartDisposition”/>
         <xs:element ref=“aex:SerialNumber”/>
         <xs:element name=“PriceAmount”/>
         <xs:element name=“SB_Applied”/>
         </xs:sequence>
         </xs:complexType>
         </xs:element>
         </xs:sequence>
         </xs:complexType>
         </xs:element>
         </xs:sequence>
         <xs:attribute name=“stepAttribute”/>
         </xs:complexType>
         </xs:element>
         <xs:element name=“SFRSummary”>
         <xs:complexType>
         <xs:sequence>
         <xs:element name=“EvaluationResult”/>
         <xs:element name=“WorkscopePerformed”/>
         <xs:element name=“WorkPerformedDescription”/>
         <xs:element name=“ActionsTakenDescription”/>
         <xs:element name=“SB_Installed”/>
         <xs:element name=“ConfirmsReasonForRemoval”/>
         <xs:element name=“IsModified”/>
         <xs:element name=“WorkscopeRequirementsComplied”/>
         <xs:element name=“SB_Incoming”/>
         <xs:element name=“Documents” maxOccurs=“2”>
         <xs:complexType>
         <xs:sequence>
         <xs:element ref=“aex:FileReference”/>
         </xs:sequence>
         </xs:complexType>
         </xs:element>
         </xs:sequence>
         </xs:complexType>
         </xs:element>
         </xs:sequence>
         </xs:complexType>
         </xs:element>
         </xs:sequence>
      </xs:complexType>
   </xs:element>
   </xs:sequence>
   </xs:complexType>
   </xs:element>
</xs:schema>.

As will be understood by those of ordinary skill in the art, other implementations consistent with this disclosure are possible for the described data structures and are considered to be within the scope of this disclosure.

Turning to FIG. 2B, FIG. 2B is a continuation 200b of the partial example representation 200a of the XML schema of FIG. 2A for representing an example electronic SFR common message structure, according to an implementation of the present disclosure. As can be seen in FIG. 2B, child elements 208a and 210a have been expanded into multiple associated child elements. Focusing on child element “aex:RepairProcessContext” 210a, associated child elements in the XML hierarchy include “aex:IncomingInspection” 202b, “aex:SFR WorkFlow” 204b, and “aex:SFRSummary” 206b.

FIG. 2C is a continuation of the example partial representation of the XML schema of FIGS. 2A and 2B, respectively, for representing an example electronic SFR common message structure, according to an implementation of the present disclosure. FIG. 2C further defines child elements associated with child elements 202b, 204b, and 206b.

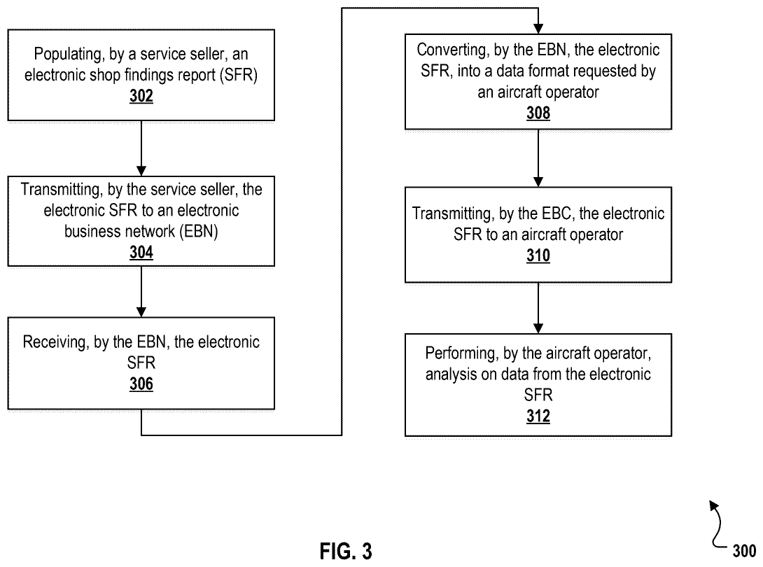

FIG. 3 is a flowchart illustrating an example of a computer-implemented method 300 for providing an Electronic SFR, according to an implementation of the present disclosure. For clarity of presentation, the description that follows generally describes method 300 in the context of the other figures in this description. However, it will be understood that method 300 can be performed, for example, by any system, environment, software, and hardware, or a combination of systems, environments, software, and hardware, as appropriate. In some implementations, various steps of method 300 can be run in parallel, in combination, in loops, or in any order.

At 302, populating, by a service seller, an electronic shop findings report (SFR). From 302, method 300 proceeds to 304.

At 304, transmitting, by the service seller, the electronic SFR to an electronic business network (EBN). From 304, method 300 proceeds to 306.

At 306, receiving, by the EBN, the electronic SFR. From 306, method 300 proceeds to 308.

At 308, converting, by the EBN, the electronic SFR, into a data format requested by an aircraft operator. From 308, method 300 proceeds to 310.

At 310, transmitting, by the EBN, the electronic SFR to an aircraft operator. From 310, method 300 proceeds to 312.

At 312, performing, by the aircraft operator, analysis on data retrieved from the electronic SFR. After 312, method 300 can stop.

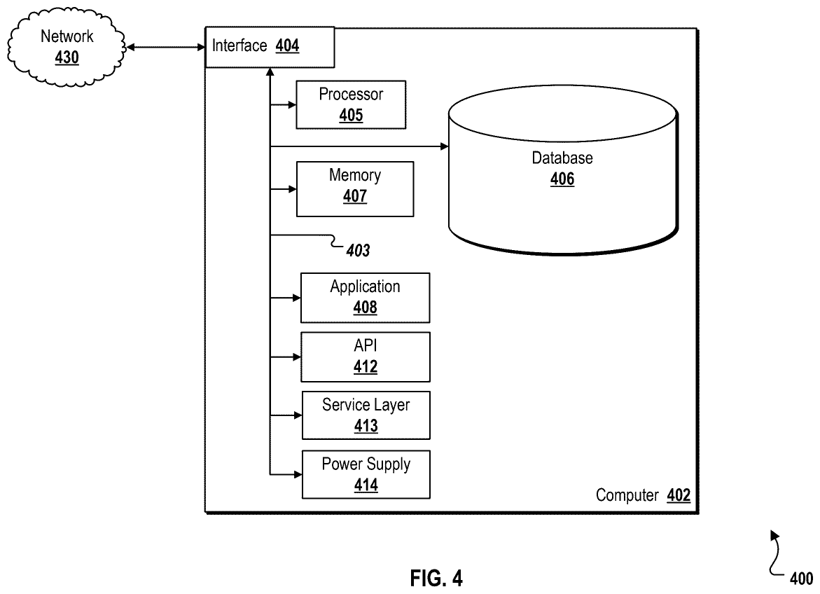

FIG. 4 is a block diagram illustrating an example of a computer-implemented System 400 used to provide computational functionalities associated with described algorithms, methods, functions, processes, flows, and procedures, according to an implementation of the present disclosure. In the illustrated implementation, computer-implemented system 400 includes a Computer 402 and a Network 430.

The illustrated Computer 402 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 402 can include an input device, such as a keypad, keyboard, or touch screen, or a combination of input devices that can accept user information, and an output device that conveys information associated with the operation of the Computer 402, including digital data, visual, audio, another type of information, or a combination of types of information, on a graphical-type user interface (UI) (or GUI) or other UI.

The Computer 402 can serve in a role in a distributed computing system as, for example, a client, network component, a server, or a database or another persistency, or a combination of roles for performing the subject matter described in the present disclosure. The illustrated Computer 402 is communicably coupled with a Network 430. In some implementations, one or more components of the Computer 402 can be configured to operate within an environment, or a combination of environments, including cloud-computing, local, or global.

At a high level, the Computer 402 is an electronic computing device operable to receive, transmit, process, store, or manage data and information associated with the described subject matter. According to some implementations, the Computer 402 can also include or be communicably coupled with a server, such as an application server, e-mail server, web server, caching server, or streaming data server, or a combination of servers.

The Computer 402 can receive requests over Network 430 (for example, from a client software application executing on another Computer 402) and respond to the received requests by processing the received requests using a software application or a combination of software applications. In addition, requests can also be sent to the Computer 402 from internal users (for example, from a command console or by another internal access method), external or third-parties, or other entities, individuals, systems, or computers.

Each of the components of the Computer 402 can communicate using a System Bus 403. In some implementations, any or all of the components of the Computer 402, including hardware, software, or a combination of hardware and software, can interface over the System Bus 403 using an application programming interface (API) 412, a Service Layer 413, or a combination of the API 412 and Service Layer 413. The API 412 can include specifications for routines, data structures, and object classes. The API 412 can be either computer-language independent or dependent and refer to a complete interface, a single function, or even a set of APIs. The Service Layer 413 provides software services to the Computer 402 or other components (whether illustrated or not) that are communicably coupled to the Computer 402. The functionality of the Computer 402 can be accessible for all service consumers using the Service Layer 413. Software services, such as those provided by the Service Layer 413, provide reusable, defined functionalities through a defined interface. For example, the interface can be software written in a computing language (for example JAVA or C++) or a combination of computing languages, and providing data in a particular format (for example, Extensible markup language (XML)) or a combination of formats. While illustrated as an integrated component of the Computer 402, alternative implementations can illustrate the API 412 or the Service Layer 413 as stand-alone components in relation to other components of the Computer 402 or other components (whether illustrated or not) that are communicably coupled to the Computer 402. Moreover, any or all parts of the API 412 or the Service Layer 413 can be implemented as a child or a sub-module of another software module, enterprise application, or hardware module without departing from the scope of the present disclosure.

The Computer 402 includes an Interface 404. Although illustrated as a single Interface 404, two or more Interfaces 404 can be used according to particular needs, desires, or particular implementations of the Computer 402. The Interface 404 is used by the Computer 402 for communicating with another computing system (whether illustrated or not) that is communicatively linked to the Network 430 in a distributed environment. Generally, the Interface 404 is operable to communicate with the Network 430 and includes logic encoded in software, hardware, or a combination of software and hardware. More specifically, the Interface 404 can include software supporting one or more communication protocols associated with communications such that the Network 430 or hardware of Interface 404 is operable to communicate physical signals within and outside of the illustrated Computer 402.

The Computer 402 includes a Processor 405. Although illustrated as a single Processor 405, two or more Processors 405 can be used according to particular needs, desires, or particular implementations of the Computer 402. Generally, the Processor 405 executes instructions and manipulates data to perform the operations of the Computer 402 and any algorithms, methods, functions, processes, flows, and procedures as described in the present disclosure.

The Computer 402 also includes a Database 406 that can hold data for the Computer 402, another component communicatively linked to the Network 430 (whether illustrated or not), or a combination of the Computer 402 and another component. For example, Database 406 can be an in-memory or conventional database storing data consistent with the present disclosure. In some implementations, Database 406 can be a combination of two or more different database types (for example, a hybrid in-memory and conventional database) according to particular needs, desires, or particular implementations of the Computer 402 and the described functionality. Although illustrated as a single Database 406, two or more databases of similar or differing types can be used according to particular needs, desires, or particular implementations of the Computer 402 and the described functionality. While Database 406 is illustrated as an integral component of the Computer 402, in alternative implementations, Database 406 can be external to the Computer 402. The Database 406 can hold and operate on at least any data type mentioned or any data type consistent with this disclosure.

The Computer 402 also includes a Memory 407 that can hold data for the Computer 402, another component or components communicatively linked to the Network 430 (whether illustrated or not), or a combination of the Computer 402 and another component. Memory 407 can store any data consistent with the present disclosure. In some implementations, Memory 407 can be a combination of two or more different types of memory (for example, a combination of semiconductor and magnetic storage) according to particular needs, desires, or particular implementations of the Computer 402 and the described functionality. Although illustrated as a single Memory 407, two or more Memories 407 or similar or differing types can be used according to particular needs, desires, or particular implementations of the Computer 402 and the described functionality. While Memory 407 is illustrated as an integral component of the Computer 402, in alternative implementations, Memory 407 can be external to the Computer 402.

The Application 408 is an algorithmic software engine providing functionality according to particular needs, desires, or particular implementations of the Computer 402, particularly with respect to functionality described in the present disclosure. For example, Application 408 can serve as one or more components, modules, or applications. Further, although illustrated as a single Application 408, the Application 408 can be implemented as multiple Applications 408 on the Computer 402. In addition, although illustrated as integral to the Computer 402, in alternative implementations, the Application 408 can be external to the Computer 402.

The Computer 402 can also include a Power Supply 414. The Power Supply 414 can include a rechargeable or non-rechargeable battery that can be configured to be either user- or non-user-replaceable. In some implementations, the Power Supply 414 can include power-conversion or management circuits (including recharging, standby, or another power management functionality). In some implementations, the Power Supply 414 can include a power plug to allow the Computer 402 to be plugged into a wall socket or another power source to, for example, power the Computer 402 or recharge a rechargeable battery.

There can be any number of Computers 402 associated with, or external to, a computer system containing Computer 402, each Computer 402 communicating over Network 430. Further, the term “client,” “user,” or other appropriate terminology can be used interchangeably, as appropriate, without departing from the scope of the present disclosure. Moreover, the present disclosure contemplates that many users can use one Computer 402, or that one user can use multiple computers 402.

Described implementations of the subject matter can include one or more features, alone or in combination.

For example, in a first implementation, a computer-implemented method, comprising: populating, by a service seller, an electronic shop findings report (SFR); transmitting, by the service seller, the electronic SFR to an electronic business network (EBN); receiving, by the EBN, the electronic SFR; converting, by the EBN, the electronic SFR, into a data format requested by an aircraft operator; transmitting, by the EBN, the electronic SFR to an aircraft operator; and performing, by the aircraft operator, analysis on data retrieved from the electronic SFR.

The foregoing and other described implementations can each, optionally, include one or more of the following features:

A first feature, combinable with any of the following features, wherein the electronic SFR is formatted in Extensible markup language (XML).

A second feature, combinable with any of the previous or following features, wherein the analysis is statistical analysis.

A third feature, combinable with any of the previous or following features, wherein the analysis is performed by artificial intelligence (AI).

A fourth feature, combinable with any of the previous or following features, wherein the EBN converts the electronic SFR into a data format that is different than that of the electronic SFR.

A fifth feature, combinable with any of the previous or following features, comprising: performing, by the EBN and as EBN analysis, analysis on data retrieved from the electronic SFR.

A sixth feature, combinable with any of the previous or following features, comprising: transmitting, by the EBN and to the aircraft operator, a result of the EBN analysis.

In a second implementation, a non-transitory, computer-readable medium storing one or more instructions executable by a computer system to perform one or more operations, comprising: populating, by a service seller, an electronic shop findings report (SFR); transmitting, by the service seller, the electronic SFR to an electronic business network (EBN); receiving, by the EBN, the electronic SFR; converting, by the EBN, the electronic SFR, into a data format requested by an aircraft operator; transmitting, by the EBN, the electronic SFR to an aircraft operator; and performing, by the aircraft operator, analysis on data retrieved from the electronic SFR.

The foregoing and other described implementations can each, optionally, include one or more of the following features:

A first feature, combinable with any of the following features, wherein the electronic SFR is formatted in Extensible markup language (XML).

A second feature, combinable with any of the previous or following features, wherein the analysis is statistical analysis.

A third feature, combinable with any of the previous or following features, wherein the analysis is performed by artificial intelligence (AI).

A fourth feature, combinable with any of the previous or following features, wherein the EBN converts the electronic SFR into a data format that is different than that of the electronic SFR.

A fifth feature, combinable with any of the previous or following features, comprising: performing, by the EBN and as EBN analysis, analysis on data retrieved from the electronic SFR.

A sixth feature, combinable with any of the previous or following features, comprising: transmitting, by the EBN and to the aircraft operator, a result of the EBN analysis.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: populating, by a service seller, an electronic shop findings report (SFR); transmitting, by the service seller, the electronic SFR to an electronic business network (EBN); receiving, by the EBN, the electronic SFR; converting, by the EBN, the electronic SFR, into a data format requested by an aircraft operator; transmitting, by the EBN, the electronic SFR to an aircraft operator; and performing, by the aircraft operator, analysis on data retrieved from the electronic SFR.

The foregoing and other described implementations can each, optionally, include one or more of the following features:

A first feature, combinable with any of the following features, wherein the electronic SFR is formatted in Extensible markup language (XML).

A second feature, combinable with any of the previous or following features, wherein the analysis is statistical analysis.

A third feature, combinable with any of the previous or following features, wherein the analysis is performed by artificial intelligence (AI).

A fourth feature, combinable with any of the previous or following features, wherein the EBN converts the electronic SFR into a data format that is different than that of the electronic SFR.

A fifth feature, combinable with any of the previous or following features, comprising: performing, by the EBN and as EBN analysis, analysis on data retrieved from the electronic SFR.

A sixth feature, combinable with any of the previous or following features, comprising: transmitting, by the EBN and to the aircraft operator, a result of the EBN analysis.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
populating, by a service seller, an electronic shop findings report (SFR);
transmitting, by the service seller, the electronic SFR to an electronic business network (EBN);
receiving, by the EBN, the electronic SFR;
converting, by the EBN, the electronic SFR, into a data format requested by an aircraft operator;
transmitting, by the EBN, the electronic SFR to an aircraft operator; and
performing, by the aircraft operator, analysis on data retrieved from the electronic SFR.

2. The computer-implemented method of claim 1, wherein the electronic SFR is formatted in Extensible markup language (XML).

3. The computer-implemented method of claim 1, wherein the analysis is statistical analysis.

4. The computer-implemented method of claim 1, wherein the analysis is performed by artificial intelligence (AI).

5. The computer-implemented method of claim 1, wherein the EBN converts the electronic SFR into a data format that is different than that of the electronic SFR.

6. The computer-implemented method of claim 1, comprising:
performing, by the EBN and as EBN analysis, analysis on data retrieved from the electronic SFR.

7. The computer-implemented method of claim 6, comprising:
transmitting, by the EBN and to the aircraft operator, a result of the EBN analysis.

8. A non-transitory, computer-readable medium storing one or more instructions executable by a computer system to perform one or more operations, comprising:
populating, by a service seller, an electronic shop findings report (SFR);
transmitting, by the service seller, the electronic SFR to an electronic business network (EBN);
receiving, by the EBN, the electronic SFR;
converting, by the EBN, the electronic SFR, into a data format requested by an aircraft operator;
transmitting, by the EBN, the electronic SFR to an aircraft operator; and
performing, by the aircraft operator, analysis on data retrieved from the electronic SFR.

9. The non-transitory, computer-readable medium of claim 8, wherein the electronic SFR is formatted in Extensible markup language (XML).

10. The non-transitory, computer-readable medium of claim 8, wherein the analysis is statistical analysis.

11. The non-transitory, computer-readable medium of claim 8, wherein the analysis is performed by artificial intelligence (AI).

12. The non-transitory, computer-readable medium of claim 8, wherein the EBN converts the electronic SFR into a data format that is different than that of the electronic SFR.

13. The non-transitory, computer-readable medium of claim 8, comprising:
performing, by the EBN and as EBN analysis, analysis on data retrieved from the electronic SFR.

14. The non-transitory, computer-readable medium of claim 13, comprising:
transmitting, by the EBN and to the aircraft operator, a result of the EBN analysis.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
populating, by a service seller, an electronic shop findings report (SFR);
transmitting, by the service seller, the electronic SFR to an electronic business network (EBN);
receiving, by the EBN, the electronic SFR;
converting, by the EBN, the electronic SFR, into a data format requested by an aircraft operator;
transmitting, by the EBN, the electronic SFR to an aircraft operator; and
performing, by the aircraft operator, analysis on data retrieved from the electronic SFR.

16. The computer-implemented system of claim 15, wherein the electronic SFR is formatted in Extensible markup language (XML).

17. The computer-implemented system of claim 15, wherein the analysis is statistical analysis.

18. The computer-implemented system of claim 15, wherein the analysis is performed by artificial intelligence (AI).

19. The computer-implemented system of claim 15, wherein the EBN converts the electronic SFR into a data format that is different than that of the electronic SFR.

20. The computer-implemented system of claim 15, comprising:
performing, by the EBN and as EBN analysis, analysis on data retrieved from the electronic SFR.

21. The computer-implemented system of claim 20, comprising:
transmitting, by the EBN and to the aircraft operator, a result of the EBN analysis.
